(19) United States
(12) Patent Application Publication
(10) Pub. No.: US 2011/0069655 A1
(43) Pub. Date: Mar. 24, 2011

(54) RELAY STATION APPARATUS, MULTIHOP SYSTEM AND RELAYING METHOD

(76) Inventor: Tetsu Ikeda, Tokyo (JP)

(21) Appl. No.: 12/993,131

(22) PCT Filed: Apr. 20, 2009
(86) PCT No.: PCT/JP2009/057837

§ 371 Date: Nov. 17, 2010

(30) Foreign Application Priority Data
May 29, 2008 (JP) 2008-141408

(51) Int. Cl. H04B 7/14

(52) U.S. Cl. 370/315

(57) ABSTRACT

A relay station apparatus includes a first transmission/receiving means and second transmission/receiving means. The first transmission/receiving means exchanges a first relay link signal transmitted/received by a superordinate apparatus, with the superordinate apparatus and exchanges part of the first relay link signal as a second access link signal or a second relay link signal, with a subordinate apparatus. The second transmission/receiving means exchanges the other part of the first relay link signal, which the first transmission/receiving means exchanges with the superordinate apparatus, as a third access link signal or a third relay link signal, with a subordinate apparatus.

### TECHNICAL FIELD

The present invention relates to a multihop system that relays signals between a terminal and a base station apparatus by multiple hops of radio links.

### BACKGROUND ART

In WiMAX (Worldwide Interoperability for Microwave Access), there are cases in which relay stations are disposed between a terminal apparatus and a base station apparatus so as to relay signals by multiple hops of radio links. The system that relays signals between a terminal apparatus and a base station apparatus through multiple hops of radio links is generally called a multihop system.

Use of a multihop system makes it possible to cover a dead zone created by an obstruction, the underground and other areas by use of relay stations. Further, in the multihop system, it is possible to obtain a better communication status in each radio link than that when a terminal apparatus and a base station apparatus are connected directly. As a result, it is possible to use a modulation scheme having high frequency usage efficiency, hence this enhances the frequency usage efficiency of the whole system.

Under the circumstances as described above, multiple kinds of frame formats have been proposed in WiMAX in prospect of applying various multihop systems (see IEEE C802.16j-08/106, “Proposal for Full Duplex relay”, Takki Yu et al. 2008/5/9).

According to this document, it is presumed that a frame format shown in FIG. 2 is applied to the multihop system that has the configuration shown in FIG. 1. The multihop system in FIG. 1 includes base station apparatus BS and relay station apparatus RS. Mobile terminal MS is connected to base station apparatus BS via relay station apparatus RS. This system is a system that is effective in a case where no inter-cell interference will occur even when the same frequency as that of access links of base station apparatus BS is used for the access links of a relay station apparatus in order for relay station apparatus RS to cover the communication area under the ground, for example. Mobile station apparatus MS can also be connected directly to base station apparatus BS.

Relay station apparatus RS of this multihop system is equipped with antenna sets for a relay link for connection to base station apparatus BS and for access links for connection to mobile station apparatuses MS. The same frequency f1 is used for the antenna set for relay links and the antenna set for access links. When a communication area under the ground is covered, the antenna for relay links is installed on the ground and the antenna for access links is installed under the ground.

In a time division multiplexing WiMAX system, uplink signals and downlink signals are divided in the time domain. In this multihop system, uplink signals and down link signals are relayed by relay station apparatus RS.

Referring to the frame format in FIG. 2, the downlink signals and the uplink signals of base station apparatus BS are temporally divided into an access zone (AZ: Access Zone) for direct access to mobile station apparatus MS and a relay zone (RZ: Relay Zone) for connection to relay station apparatus RS. The access link signals are transmitted in the access zone and the relay link signals are transmitted in the relay zone. Relay station apparatus RS establishes connection with base station apparatus BS by the antenna set for relay links (Ant set1) and establishes connection with mobile terminal MS by antenna set (Ant set2) for access links. Relay station apparatus RS transmits the downlink signal received from base station apparatus BS by Ant set1, to mobile terminal MS from Ant set2. Also, relay station apparatus RS transmits the uplink signal received from mobile terminal MS by Ant set2, to base station apparatus BS from Ant set1.

In accordance with this configuration, relay station apparatus RS covers the communication area under the ground, whereby it is possible for base station apparatus BS to accommodate mobile terminals MS existing in that communication area.

### DISCLOSURE OF INVENTION

In the multihop system in FIGS. 1 and 2, however, no consideration has been given to accommodating mobile terminals MS in the area on the ground where relay station apparatus RS, with high frequency usage efficiency, is installed. As a result, it is necessary to make base station apparatus BS directly accommodate the mobile terminals MS located around relay station apparatus RS by using a modulating scheme having low frequency usage efficiency, or provide another relay station apparatus in order to cover the communication area on the ground around relay station apparatus RS for the underground.

The object of the present invention is to provide a technology for constructing a multihop system that can accommodate terminal apparatuses with higher efficiency.

In order to attain the above, object, a relay station apparatus according to the present invention includes:

a first transmission/receiving means that exchanges a first relay link signal, transmitted/received by a superordinate apparatus, with the superordinate apparatus and exchanges part of the first relay link signal, as a second access link signal or a second relay link signal, with a subordinate apparatus; and,

a second transmission/receiving means that exchanges the other part of the first relay link signal, which the first transmission/receiving means exchanges with the superordinate apparatus, as a third access link signal or a third relay link signal, with a subordinate apparatus.

A multihop system of the present invention includes:

a base station apparatus that transmits/receives a relay link signal for establishing connection with a terminal apparatus in multihops;

a relay station apparatus including a first transmission/receiving means and a second transmission/receiving means, the first transmission/receiving means exchanging a first relay link signal with the base station apparatus or another relay station as a superordinate apparatus and exchanging a part of the first relay link signal as a second access link signal or a second relay link signal, with a terminal apparatus or another relay station as a subordinate apparatus, and, the second transmission/receiving means exchanging the other part of the first relay link signal, which the first transmission/receiving means exchanges with the superordinate apparatus, as a third access link signal or a third relay link signal, with a subordinate apparatus.

A relaying method of the present invention is a relaying method in a relay station apparatus of a multihop system for connecting between a base station apparatus and a terminal apparatus in multihops, comprising the steps of:

by means of a first transmission/receiving means provided for the relay station apparatus, exchanging a first relay link signal that is transmitted or received by the base station apparatus or another relay station as a superordinate apparatus, with the superordinate apparatus and exchanging part of the first relay link signal as a second access link signal or a second relay link signal, with a terminal apparatus or another relay station as a subordinate apparatus, and,

by means of a second transmission/receiving means provided for the relay station apparatus, exchanging the other part of the first relay link signal, which the first transmission/receiving means exchanges with the superordinate apparatus, as a third access link signal or a third relay link signal, with a subordinate apparatus.

### BRIEF DESCRIPTION OF THE DRAWINGS

FIG. 1 is a block diagram showing a configuration of a multihop system based on a proposal.

FIG. 2 is a diagram showing a frame format used in the multihop system in FIG. 1.

FIG. 3 is a block diagram showing a configuration of a multihop system according to the present exemplary embodiment

FIG. 4 is a block diagram showing a configuration of relay station apparatus RS of the present exemplary embodiment.

FIG. 5 is a diagram showing a frame format used in a multihop system of the present exemplary embodiment.

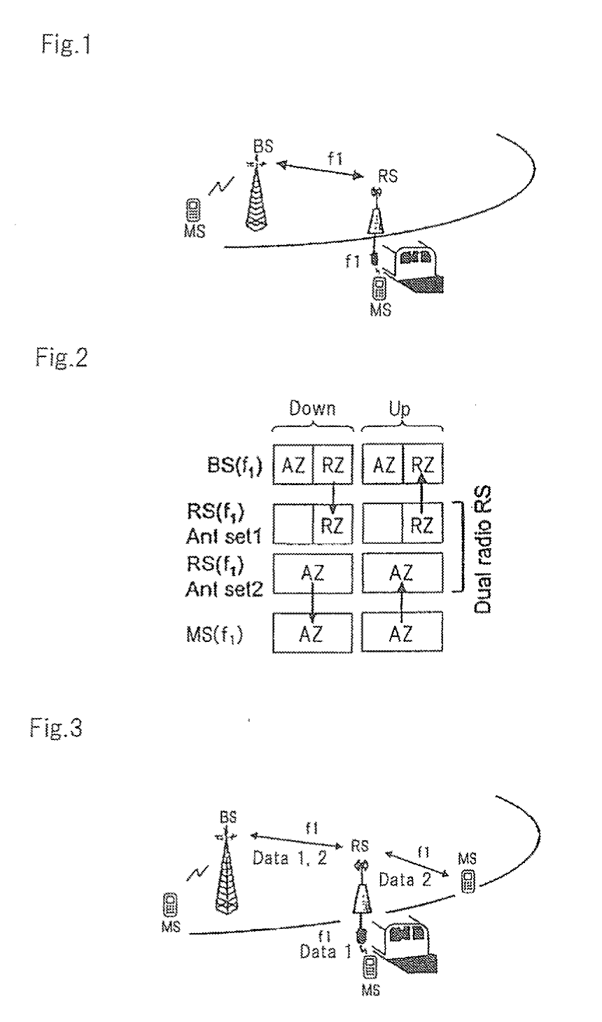

### BEST MODE FOR CARRYING OUT THE INVENTION

The mode for carrying out the present invention will be described in detail with reference to the drawings.

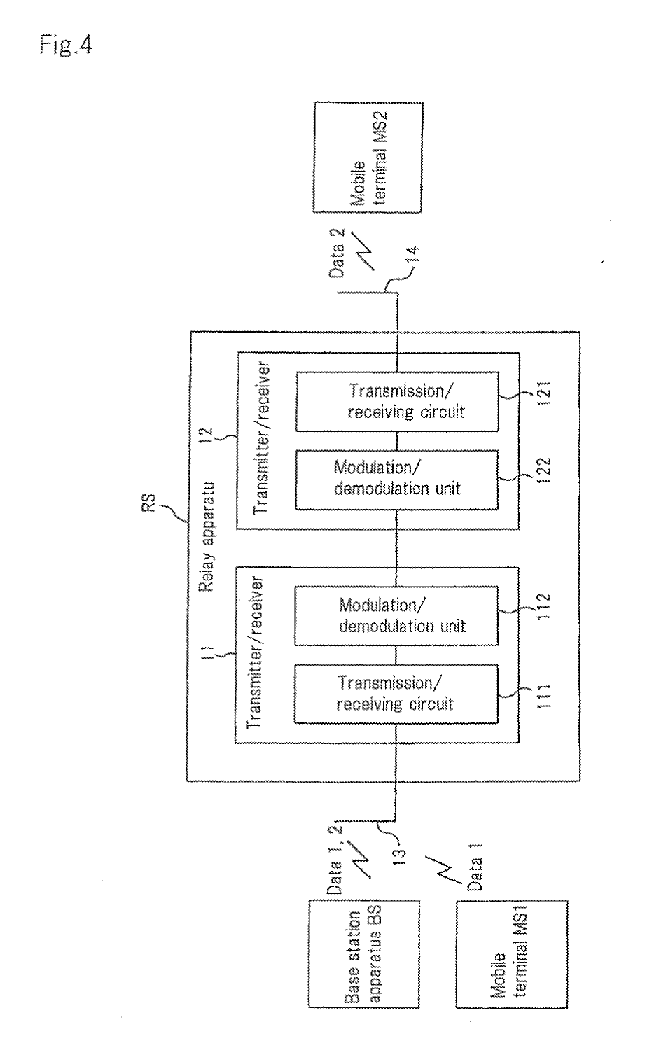

FIG. 3 is a block diagram showing a configuration of a multihop system according to the present exemplary embodiment. Referring to FIG. 3, the multihop system of the present exemplary embodiment includes base station apparatus BS and relay station apparatus RS.

Base station apparatus BS is an apparatus that connects mobile terminals MS to an unillustrated backbone network. Base station apparatus BS directly connects to mobile terminal MS by an access link and connects to mobile terminal MS through relay station apparatus RS that is connected by a relay link.

A relay link is an radio link for relaying signals between the base station apparatus and a relay station apparatus or between relay station apparatuses in this multihop system, and is a radio link between base station apparatus BS and relay station apparatus RS in this exemplary embodiment. A plurality of hops of relay station apparatuses RS may be deployed between base station apparatus BS and mobile terminal MS so as to realize a relaying three or more hops.

An access link is a radio link by which the present multihop system, as a radio access network, accommodates mobile terminal MS, and is a radio link that connects between base station apparatus BS or relay station apparatus RS and mobile terminal MS in the example of the exemplary embodiment.

Relay station apparatus RS is an apparatus that is disposed between base station apparatus BS and mobile terminal MS to relay signals, is connected to base station apparatus BS by a relay link and is connected to mobile terminal MS by an access link. Relay station apparatus RS in the present exemplary embodiment includes two antenna sets, and relays data 1 and data 2, that are to be transmitted through the relay link between base station apparatus BS and relay station apparatus RS, to the access links of different antenna sets. One of the two antenna sets is also used for connecting the relay link with base station apparatus BS. In this example, relay station apparatus RS relays data 1 to the access link of the antenna set that is used for the relay link to base station apparatus BS. In the present exemplary embodiment, the same frequency f1 is used for the two antenna sets.

FIG. 4 is a block diagram showing a configuration of relay station apparatus RS of the present exemplary embodiment. Referring to FIG. 4, relay station apparatus RS includes transmitter/receivers 11 and 12.

Transmitter/receiver 11 exchanges relay link signals with base station apparatus BS (data 1 and 2), with base station apparatus BS. Transmitter/receiver 11 also exchanges part of the relay link signals (data 1) with mobile terminal MS1 by the access link.

Transmitter/receiver 11 includes transmission/receiving circuit 111 and modulation/demodulation unit 112. Transmission/receiving circuit 111 exchanges radio signals of frequency f1 with base station apparatus BS and mobile terminal MS1 via antenna 13. Modulation/demodulation unit 112 modulates and demodulates signals transmitted/received by transmitter/receiver circuit 111.

The downlink signals transmitted by base station apparatus BS and the uplink signals received by base station apparatus BS are time-division multiplexed. In each of the uplink and the downlink signals, relay link signals and access link signals that are to be directly connected between base station apparatus BS and the mobile terminal are time-division multiplexed so that they are distributed to different zones from each other. Transmitter/receiver 11 exchanges access link signals with mobile terminal MS1 in the zone through which base station apparatus BS exchanges access link signals.

Transmitter/receiver 12 is provided separately from transmitter/receiver 11 and exchanges another part (data 2) of the relay link signals that are exchanged with base station apparatus BS by transmitter/receiver 11, with mobile terminal MS2 by the access link. Transmitter/receiver 12 includes transmission/receiving circuit 121 and modulation/demodulation unit 122. Transmission/receiving circuit 121 exchanges radio signals of frequency f1 with mobile terminal MS2 via antenna 14. Modulation/demodulation unit 122 modulates and demodulates signals transmitted/received by transmitter/receiver circuit 121.

Antennas 13 and 14 are preferably arranged so that the communication area in which mobile terminal MS1 is connected by transmitter/receiver 11 and the communication area in which mobile terminal MS2 is connected by transmitter/receiver 12 will not interfere with each other. For example, it is considered that antenna 13 of transmitter/receiver 11 that is to be used for connection with base station apparatus BS is disposed on the ground while antenna 14 of transmitter/receiver 12 dedicatedly used for connection with mobile terminals MS is disposed under the ground.

In the present system, an adaptive modulation method in which the scheme of modulation varies depending on the status of the radio channel. In modulation/demodulation units 112 and 122, a plurality of modulation schemes that differ in characteristics such as, for example QAM and QPSK are supported. The modulation scheme having the higher frequency usage efficiency is used when the status of the radio channel is relatively good, whereas the modulation scheme that is robust against errors is used when the status of the radio channel is relatively poor.

In the downlink, modulation/demodulation unit 112 demodulates the relay link signal (data 1 and 2) that was received from base station apparatus BS at transmission/receiving circuit 111, based on the modulation scheme used for that signal and part of data (data 1) of the signal obtained after demodulation is re-modulated based on a new modulation scheme so that the modulated signal is transmitted to mobile terminal MS1 via transmission/receiving circuit 111. The other part (data 2) of the signal obtained after demodulation by modulation/demodulation unit 112 is modulated by modulation/demodulation unit 122 based on a new modulation scheme, so that the modulated signal is transmitted to mobile terminal MS2 via transmission/receiving circuit 121.

In the uplink, modulation/demodulation unit 122 demodulates the access link signal (data 2) that was received from mobile terminal MS2 at transmission/receiving circuit 121, based on the modulation scheme used for that signal. Modulation/demodulation unit 112 demodulates the access link signal (data 1) that was received from mobile terminal MS1 by transmission/receiving circuit 111, based on the modulation scheme used for that signal. Then, modulation/demodulation unit 112 modulates the signal obtained by demodulation thereof and the signal obtained by demodulation by modulation/demodulation unit 122, based on the new modulation scheme and transmits the modulated signals to base station apparatus BS via transmission/receiving circuit 111.

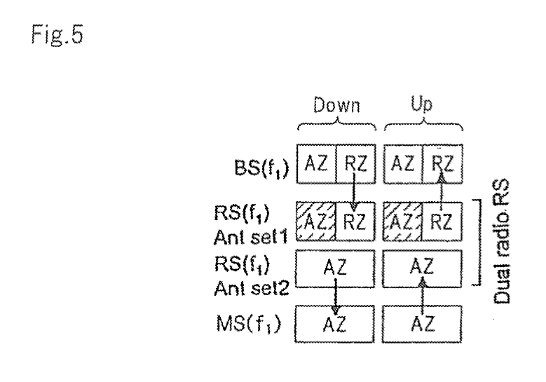

FIG. 5 is a diagram showing a frame format used in a multihop system of the present exemplary embodiment. Referring to the frame format in FIG. 5, the frames transmitted and received by base station apparatus BS are temporally divided into access zones (AZ: Access Zone) for direct connection to mobile terminals MS, relay zones (RS: Relay Zone) for connection to relay station apparatus RS. Access link signals are transmitted in access zones and relay link signals are transmitted in relay link zones.

In a frame transmitted or received by transmitter/receiver 11 of relay station apparatus RS (corresponding to Antenna set1), the access link signal transmitted to mobile terminal MS1 or received from mobile terminal MS1 and the relay link signal transmitted to base station apparatus BS or received from base station apparatus BS are time-division multiplexed. Then, the access link signal in the frame transmitted or received by transmitter/receiver 11 is disposed in the access zone.

As described heretofore, according to the present exemplary embodiment, relay station apparatus RS includes two transmitter/receivers 11 and 12, so that access link signals are exchanged with mobile terminal MS2 by transmitter/receiver 12 and in addition, transmitter/receiver 11 for exchanging relay link signals with base station apparatus BS is also used to exchange access link signals with mobile terminal MS1. Accordingly, it is possible to construct a multihop system that can accommodate mobile terminals MS more efficiently.

Further, according to the present exemplary embodiment, relay station apparatus RS exchanges access link signals with mobile terminal MS1 in the access zone, using transmitter/receiver 11. Accordingly, it is possible to make efficient use of access zones for time-division multiplexing to accommodate mobile terminals.

Further, when mutually joining the relay link signal exchanged with base station apparatus BS by transmitter/receiver 11 and the access link signal exchanged with mobile terminal MS by transmitter/receiver 11 or transmitter/receiver 12, relay station apparatus RS demodulates the signals once and then re-modulates the signals based on a new modulation scheme, in accordance with an adaptive modulation method. Each radio link in the multihops is improved in the quality of radio channel compared to the radio link when mobile terminal MS is directly connected to base station apparatus BS. Since a modulating scheme suited to the status of the radio channel is selected in the adaptive modulation method, the modulation scheme having the high frequency usage efficiency in each radio link in the multihops is used. As a result, improved frequency usage efficiency can be obtained so that in each of the communication areas covered by transmitter/receiver 11 and transmitter/receiver 12, it is possible to accommodate mobile terminals MS more efficiently.

Since the signals are once demodulated at transmitter/receiver 11 and transmitter/receiver 12 and re-modulated based on a new modulation scheme, the modulation scheme on the relay link between base station apparatus BS and relay station apparatus RS and the modulation scheme on the access links between relay station apparatus RS and mobile terminals MS1 and MS2 are selected independently. If a cell design is planned so that the channel quality of the relay link between base station apparatus BS and relay station apparatus RS will become better than the channel quality of the access links between relay station apparatus RS and mobile terminals MS1 and MS2, the adaptation of transmitter/receiver 11 to exchange access link signals with mobile terminal MS1 when it does not exchange relay link signals with base station apparatus BS, makes it possible to fully use the expanded band for access links, thus resulting in accommodating mobile terminals in a further efficient manner.

Further, as described above, in relay station apparatus RS of the present exemplary embodiment, it is preferable that antennas 13 and 14 are arranged so that the communication area in which mobile terminal MS1 is connected by transmitter/receiver 11 and the communication area in which mobile terminal MS2 is connected by transmitter/receiver 12 will not interfere with each other. In this case, it is possible to use the same frequency f1 for both transmitter/receiver 11 and transmitter/receiver 12, hence it is possible to efficiently use the frequency that is allotted to the system.

As the exemplary embodiment of the present invention has been described heretofore, the present invention should not be limited to this exemplary embodiment, but the configurations may be combined and part of the configuration may be modified within the technical scope of the present invention.

This application claims priority, based on Japanese Patent Application 2008-141408 filed on May 29, 2008, and should incorporate all the disclosure thereof herein.

1. A relay station apparatus comprising:
a first transmission/receiving unit that exchanges a first relay link signal transmitted/received by a superordinate apparatus, with the superordinate apparatus and exchanges part of the first relay link signal as a second access link signal or a second relay link signal, with a subordinate apparatus; and,
a second transmission/receiving unit that exchanges the other part of the first relay link signal, which the first transmission/receiving unit exchanges with the superordinate apparatus, as a third access link signal or a third relay link signal, with a subordinate apparatus.

2. The relay station apparatus according to claim 1, wherein the first relay link signal transmitted/received by the superordinate apparatus and the first access link signal which the superordinate apparatus directly exchanges with a subordinate apparatus are time-division multiplexed so as to be allocated to zones each different from the other, and,
the first transmission/receiving unit transmits/receives the second access link signal or the second relay link signal, in the zone in which the superordinate apparatus transmits/receives the first access link signal.

3. The relay station apparatus according to claim 1, wherein the first transmission/receiving unit and the second transmission/receiving unit demodulate a received signal and modulate a signal to be transmitted based on an adaptive modulation scheme.

4. The relay station apparatus according to claim 1, wherein the same frequency is used in the first transmission/receiving unit and the second transmission/receiving unit.

5. A multihop system comprising:
a base station apparatus that transmits/receives a relay link signal for establishing connection with a terminal apparatus in multihops;
a relay station apparatus including a first transmission/receiving unit and a second transmission/receiving unit, the first transmission/receiving unit exchanging a first relay link signal with the base station apparatus or another relay station as a superordinate apparatus and exchanging part of the first relay link signal as a second access link signal or a second relay link signal, with a terminal apparatus or another relay station as a subordinate apparatus, and, the second transmission/receiving unit exchanging the other part of the first relay link signal, which the first transmission/receiving unit exchanges with the superordinate apparatus, as a third access link signal or a third relay link signal, with a subordinate apparatus.

6. The multihop system according to claim 5, wherein the first relay link signal transmitted/received by the superordinate apparatus and the first access link signal which the superordinate apparatus transmits or receives are time-division multiplexed so as to be allocated to zones each different from the other, and,
the first transmission/receiving unit transmits/receives the second access link signal or the second relay link signal, in the zone in which the superordinate apparatus transmits and receives the first access link signal.

7. The multihop system according to claim 5, wherein the first transmission/receiving unit and the second transmission/receiving unit demodulate a received signal and modulate a signal to be transmitted based on an adaptive modulation scheme.

8. The multihop system according to claim 5, wherein the same frequency is used in the first transmission/receiving unit and the second transmission/receiving unit.

9. A relaying method in a relay station apparatus of a multihop system for connecting between a base station apparatus and a terminal apparatus in multihops, comprising the steps of:
by means of a first transmission/receiving unit provided for the relay station apparatus, exchanging a first relay link signal that is transmitted or received by the base station apparatus or another relay station as a superordinate apparatus, with the superordinate apparatus and exchanging part of the first relay link signal as a second access link signal or a second relay link signal, with a terminal apparatus or another relay station as a subordinate apparatus, and,
by means of a second transmission/receiving unit provided for the relay station apparatus, exchanging the other part of the first relay link signal, which the first transmission/receiving unit exchanges with the superordinate apparatus, as a third access link signal or a third relay link signal, with a subordinate apparatus.

10. The relaying method according to claim 9, wherein the first relay link signal transmitted/received by the superordinate apparatus and the first access link signal which the superordinate apparatus transmits or receives are time-division multiplexed so as to be allocated to zones each different from the other, and,
the first transmission/receiving unit transmits/receives the second access link signal or the second relay link signal, in the zone in which the superordinate apparatus transmits/receives the first access link signal.

11. The relaying method according to claim 9, wherein the first transmission/receiving unit and the second transmission/receiving unit demodulate a received signal and modulate a signal to be transmitted based on an adaptive modulation scheme.

12. The relaying method according to claim 9, wherein the same frequency is used in the first transmission/receiving unit and the second transmission/receiving unit.
